(19) United States
(12) Patent Application Publication
(10) Pub. No.: US 2011/0031904 A1
(43) Pub. Date: Feb. 10, 2011

(54) Shelf Supported Illuminating Display and Store Display Featuring Same

(76) Inventor: Edward Francis Carolan, Caledon (CA)

Correspondence Address: ADE & COMPANY INC., 2157 Henderson Highway, WINNIPEG, MB, R2G1P9, CA

(21) Appl. No.: 12/849,508

(22) Filed: Aug. 3, 2010

Related U.S. Application Data
(60) Provisional application No. 61/231,109, filed on Aug. 4, 2009.

(51) Int. Cl. H05B 37/02; A47F 11/10; F21V 9/16; G09F 13/00

(52) U.S. Cl. 315/313; 362/125; 362/84; 315/312; 40/541

(57) ABSTRACT

An illuminating display is arranged for support on a store shelf at the front edge thereof and features at least one illuminating display area activated by a light source and visible from a side of the display facing outward from the shelf to form an eye-catching visual display visible by browsing customers perusing the product content of the shelf. In preferred embodiments, the display is in the form of a strip dimension to fit within a price ticket channel of the shelf so as to facilitate easy and clean removal of the strip, avoid obstruction of the products displayed on the shelf and extend along the shelf to carry multiple display areas at spaced positions therealong. The display areas can present product or company names, logos or slogans, or other promotional or advertising content.

### CROSS REFERENCE TO RELATED APPLICATIONS

This application claims benefit under 35 U.S.C. 119(e) of U.S. Provisional Patent Application Ser. No. 61/231,109, filed Aug. 4, 2009.

### FIELD OF THE INVENTION

The present invention relates generally to self-illuminating promotional or advertising displays, and more particularly to such displays configured for mounting at the exposed front ends of merchandise shelving of a retail or other store environment.

### BACKGROUND OF THE INVENTION

Illuminated or self-illuminating displays or signs are well known in the fields of promotion and advertisement and employ lighting to add an additional attraction factor beyond mere print-based displays alone. Conventional examples of such displays include billboards, signs and illuminated poster cases. Known displays include those using constant illumination, intermittent illumination, flashing lights, moving beams of light, sequenced activation of multiple light sources, time varying colours of illumination and other eye-grabbing lighting effects.

In store environments, such as retail or rental outlets, it is known to use lighting to draw a consumer's attention to a particular product or group of products. Conventionally this is achieved through use of light sources supported on or separately from shelving on which the product in question are displayed to either illuminate the product or present a flashing effect intended to draw the consumer's attention through visual stimulation.

The applicant of the present application has developed an improved illuminating display particularly configured for use in a store environment to draw a consumer's attention to merchandise shelving with a more stimulating or promotional effect than the conventional lighting techniques previously applied in such settings.

### SUMMARY OF THE INVENTION

According to a first aspect of the invention there is provided an illuminating display for a store shelf having a price ticket channel extending along an outer edge of the shelf with upper and lower lips extending in a longitudinal direction of the channel at top and bottom sides thereof, the illuminating display comprising:

a strip having a width dimension sized for receipt of the strip within the channel between the upper and lower lips to extend a length dimension of the strip along the longitudinal direction of the channel; and

at least one illuminating display area defined on the strip to face outward from the channel away from the shelf and illuminate under activation of an light source carried on the strip and associated with the display area.

Preferably each illuminating display area is illuminated by a respective electroluminescent light source operably disposed at said display area.

Preferably the at least one illuminating display area comprises a plurality of illuminating display areas spaced apart along the length dimension of the strip.

Preferably one or more illuminating display areas are each configured to display name or logo.

Preferably there is provided a controller electrically coupled with each light source to control illumination of the at least one illuminating display area.

Preferably there is provided a releasable electrical interface connected between the controller and each light source to facilitate selective disconnection of the controller from each light source.

Preferably the controller is arranged to control a sequence in which multiple illuminating display areas are illuminated.

The controller may be arranged to effect illumination the multiple illuminating display areas in sequence along the strip, in which case the controller may be arranged to deactivate the illumination of each multiple illuminating display area only after all of the multiple illuminating display areas have been illuminated.

The controller may comprise a micro-controller.

According to a second aspect of the invention there is provided a store display comprising:

a shelf defining a support surface and an outer edge extending along one side of the support surface; and

an illuminating display supported on the shelf to face away from the shelf and the outer edge thereof, the illuminating display comprising:
a body secured to the shelf;
at least one illuminating display area carried on the body and visible from a side thereof facing outward from the shelf; and
at least one light source carried on the body and operable to illuminate the at least one illuminating display area.

Preferably the body of the display comprises a sheet of material on which each illuminating display area and light source are carried.

Preferably each illuminating display area is illuminated by a electroluminescent light source operably defined on the sheet of material at said illuminating display area.

Preferably the sheet of material is a strip of material having a length dimension extending along the outer edge of the shelf.

Preferably the illuminating display is provided in the form of a strip extending along the outer edge of the shelf.

Preferably a top edge of the strip is disposed at an elevation below the support surface of the shelf.

Preferably a height dimension of the strip does not exceed a height dimension of the shelf at an outermost extent of the shelf on the same side of the support surface as the outer edge.

Preferably the shelf comprises a price ticket channel extending along the outer edge on a side thereof opposite the support surface, the ticket channel comprising upper and lower lips extending in a longitudinal direction of the channel on opposite top and bottom sides of a face of channel facing away from the outer edge and the body of the illuminating display being disposed within the channel between the upper and lower lips thereof.

Preferably there is provided a controller electrically coupled with each light source to control illumination of the at least one illuminating display area.

Preferably the controller is operable at a distance from where the body of the illuminating display is secured to the shelf.

### BRIEF DESCRIPTION OF THE DRAWINGS

In the accompanying drawings, which illustrate an exemplary embodiment of the present invention:

FIG. 1 is a schematic front view of an illuminating display according to the present invention.

FIG. 2 is a schematic front perspective view of the illuminating display of FIG. 1 installed on a store shelf assembly.

FIG. 3 is an end view of the illuminating display of FIG. 2.

FIG. 4 is a chart to be considered in conjunction with FIG. 2 to illustrate a possible illumination sequence of a plurality of display areas of the illuminating display over time, wherein asterisks (*) denote illuminated display areas and hyphens (-) denote unilluminated display areas.

### DETAILED DESCRIPTION

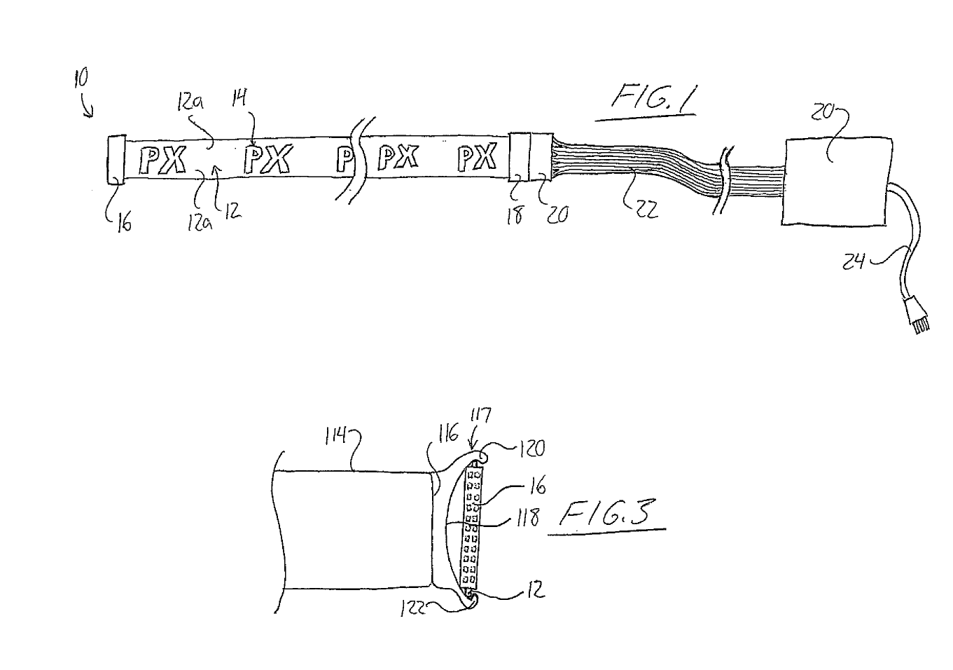

FIG. 1 shows an illuminating display 10 featuring a display body 12 in the form of a thin strip shaped electroluminescent display including a series of display areas or segments 14 defined at spaced locations along the longitudinal direction of the strip 12. In a conventional manner, the electroluminescent display is of a layered configuration featuring, in order moving away from one face of the strip to the opposite, a transparent substrate, a transparent electrode layer adjacent the substrate, a layer of electroluminescent material (phosphor) adjacent the substrate, a layer of dielectric or insulating material adjacent the layer of electroluminescent material, and a further electrode layer adjacent the layer of electroluminescent material. The transparent substrate forms or is nearest a front face 12a of the strip so that the illumination of the electroluminescent material layer acting as a light source when activated is visible at from the side of the strip to which the front face thereof is directed. In a known manner, the shape of the display areas are determined during the production of the electroluminescent display by forming separate rear electrodes of selected shapes at the positions along the resulting strip where the display areas are to be formed, and possibly forming the electroluminescent material layer as separate sections having the same shapes and positions as the shaped rear electrodes as suggested in U.S. Pat. No. 7,088,039, herein incorporated by reference. With the rear electrode layer featuring individual rear electrodes spaced from one another to define the shapes of the display areas to be illuminated, the front electrode layer can fully cover or span the full area of the strip.

Inside the laminate assembly between the two opposing faces of the laminate strip, the rear electrode of each electroluminescent display area is conductively connected to a respective electrical contact point at each of two male and female electrical connector components 16, 18 mounted to opposite ends of the strip 12 by way of conductive lead tracks or paths that may be formed on the side of the dielectric layer opposite the front electrode. Alternatively, it may possible to run wire connections to the rear electrodes of the different display areas or segments. The front electrode is likewise conductively linked to a contact at each of the two connector components at the opposite ends of the strip. A power control module 20 is electrically interfaced with the electroluminescent display areas 14 of the strip by way of a ribbon cable 22 equipped with a female IDC or other electrical connector component 20 selectively engagable with the male connector component 18 mounted at the opposite end of the strip 12. Inside its housing, the power control module features a micro-controller, micro-processor programmed as part of a driver system to control illumination of the electroluminescent display areas when a power cable 24 of the power control module is plugged into a mains power socket and the ribbon cable is coupled to the electroluminescent display strip. The micro-controller is programmed to connect and disconnect AC power to each electroluminescent display area in order to carry out an illumination sequence or pattern among the plurality of display areas to produce an eye catching visual effect. Many such controllers for multi-segment electroluminescent displays are well known in the art, and accordingly specific structural and operation details of the schematically illustrated power control module are not presented herein.

FIG. 2 shows the strip 12 of the illuminating display installed on a shelf 110 in a store environment in order to draw consumer attention to merchandise (not shown) to be displayed on the shelf 110. The shelf projects horizontally outward from a rear wall panel 112 of a shelving installation such that the shelf 110 presents a horizontal support surface 114 on which the merchandise is to be situated. In a conventional manner, the rectangular shelf features a front outer edge 116 extending parallel to the rear wall panel 112 from which the shelf projects along a side of the support surface opposite the rear wall panel 112. The illustrated shelf the type typically employed in grocery stores, where a price ticket channel 117 is secured to the shelf 110 at the front edge 116 thereof to allow insertion of price tickets into the channel to indicate pricing of the products displayed on the shelf. Different types of these channels attaching to the shelf in different ways are known, but these channels share similar structures forming a concave face 118 facing outwardly away from the front edge 116 of the shelf in a horizontal or upwardly inclined direction, and top and bottom lips 120, 122 disposed above and below the face 118. The face 118 and lips 120, 122 of the elongate channel extend parallel to the front edge 116 of the shelf defining the shelf length. The uniform cross-section of the channel 117 is somewhat C-shaped, with the top and bottom lips 120, 122 projecting outwardly away from the shelf and channel face in downward and upward directions from the opposite ends of the channel face 118 respectively.

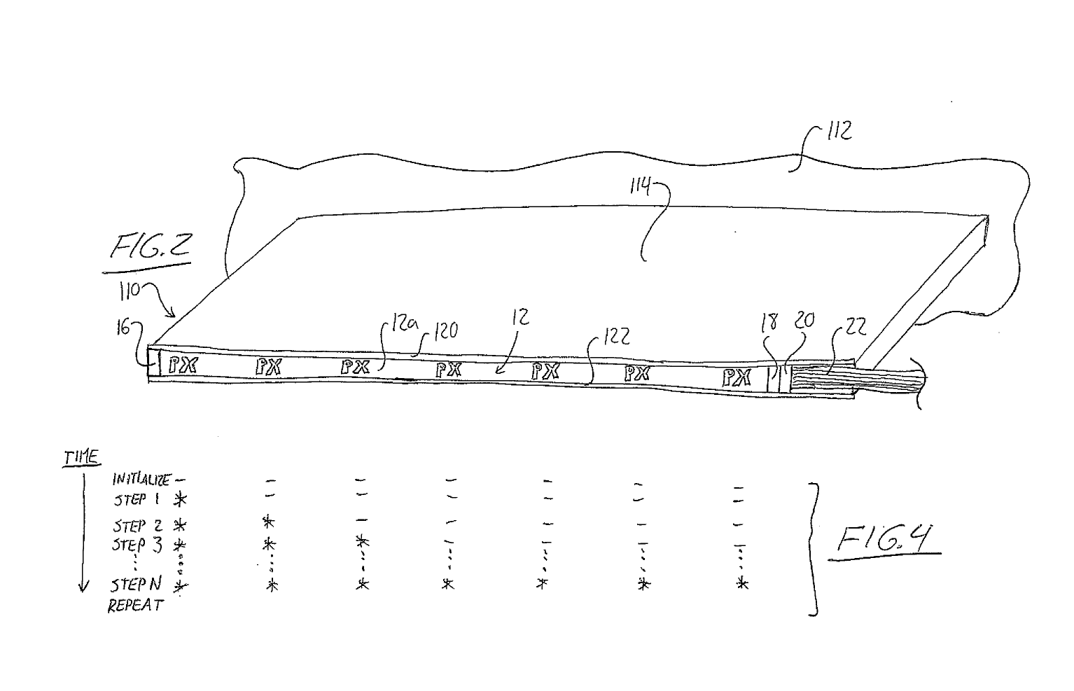

As shown in FIG. 3, the strip 12 of the illuminating display is dimensioned to fit within the channel in generally the same manner as a price ticket. That is, the width of the rectangular strip 12 does not exceed the distance between the lips 120, 122 of the channel 117 as measured along the channel's face surface 118, but does exceed the straight line distance between the lips 120, 122 at the ends thereof distal to the face 118. This way, the strip sits on the lower lip 122, or the transition from the face 118 thereto, at a position between the shelf's front edge 116 and where the lower lip projects upward toward the upper lip, and the top edge of the strip 12 is retained in the channel by the downwardly depending upper lip 120. Disposed within the price ticket channel, the illuminating display strip 12 is contained within the height or vertical distance spanned by the horizontal shelf at the outermost extent thereof furthest from the rear wall 112 were the shelf is supported. That is, the outermost part of the shelf, which is defined by the channel member 117 in the illustrated embodiment, has a thickness or height span that exceeds the straight line distance spanned by the width of the installed strip 12 between its top and bottom edges, so that the strip 12 does not project upwardly or downwardly beyond the shelf where the strip is supported and accordingly does not obscure the view of products on the shelf in question or a shelf that may be positioned therebelow.

Although the strip is shown in FIG. 3 is shown as being substantially planar when installed to fit its top and bottom edges in the channel behind the lips thereof, it will be appreciated that the strip may be produced in a slightly wider configuration for as not to stand in a planar configuration when installed, but rather have a width that slightly exceeds the straight line distance between where the top and bottom edges of the strip tuck in behind the lips of the channel so that the flexible strip bows when installed, forcing the front face of the strip to become concave between the top and bottom edges of the strip and thus more closely follow the concave face 118 of the channel or become convex between the top and bottom edges of the strip to bulge somewhat outwardly relative to the channel away from the front edge 116 of the shelf. Such dimensioning of the strip provides a tighter frication fit in the channel, to resist tampering or removal of the display from the shelf.

With the cable ribbon or another flexible electrical connection between the power control module 20 and the strip 20, the power control module may be located at a distance from the installation of the strip at the front of the shelf so as not to occupy shelf space that can more productively be used to display merchandise.

The electroluminescent display areas 14 of the illuminating display 12 may be configured to present images or text reflective of company, brand or product names, logos or slogans, or other promotional, advertising, brand recognition. In the illustrated embodiment, the electroluminescent display areas are shaped to form the letters “PX” to advertise or promote imaginary “Product X”. FIG. 4 illustrates one possible illumination sequence that the control module may be programmed or configured to execute, by using asterisks (*) and hyphens (-) positioned in alignment beneath the electroluminescent display areas of the illuminating display of FIG. 2 to reflect illuminated and non-illuminated states of the display areas in steps of the control process executed sequentially in time. In an initial step at the start of the process, none of the display areas are illuminated. After a time delay, a first one of the display areas adjacent one end of the strip is switched into its illuminated state.

After another time delay of the same value, a second one of the display areas adjacent the first is switched into its illuminated state. This same delay and activation of the next adjacent display area is repeated until all of the display areas are illuminated. Then, after an additional time delay during which all the display areas are kept illuminated, all the display areas are switched into their unilluminated states. The process is then repeated.

This provides an appealing visual display in which the display areas are activated in sequential order along the strip until all areas are illuminated, and only then deactivates them. This process may be summarized as, for a strip with N display areas, initializing the display by disconnecting all N display areas from their power source to put or keep them all in an unilluminated state. Then, for i=1 to N, performing step i in which power to display area i is switched on to put display i in its illuminated state. This is of course only one example of a possible illumination sequence or pattern. A suitable controller may be programmed to run more than one such sequence or pattern, and may accept user input to allow for selection from more than one sequence or illumination option. Other embodiments may lack any programmed lighting sequence or pattern, and for example may omit a micro-controller or other sequence control system altogether and, for example, may simply be wired for mere on and off operation for control only over putting all the display areas in an illuminated or non-illuminated state. In such an embodiment, the electroluminescent display strip may be of a backlit configuration using full length and height rear electrode and phosphor layers and employing a masking layer somewhere forward of the phosphor layer in the electroluminescent assembly to define the characters, images or shapes of the display areas spaced along the strip.

The male and female connection components at opposite ends of the strip 12 allow multiple strips to be chained together for control and powering by a single power control module 20. Preferably the electrical contacts in the male connection component to which the display area at a particular position along the strip is connected correspond to the correspondingly positioned electrical contacts in the female connection component, so that when the male and female components of two or more strips are engaged to one another to form a longer overall illuminating display, the powering of the display area at a particular position along the strip directly coupled to the power control module 20 powers the display area at the same position along the other strip(s) in the chain. This way, the same illumination sequence or pattern is executed at all the strips at effectively the same time. This way, multiple strips can be engaged together to span a longer distance along a store aisle, while avoiding the need for multiple power control modules. Each individual strip and the connection components thereon, may have a length less than, equal to or greater than a single shelf or shelving section. Strips may be manufactured in a single length short enough to fit a single strip on a single shelf for popular shelving configurations having known dimensions, or strips may be tailor made to fit particular shelving types.

Alternate embodiments could replace electroluminescent display areas with display areas relying on other light source types for illumination. For example, a strip using LED's supported behind an opaque masking portion of an elongate strip-like structure having shapes cut out of it to form letters, numbers, characters or other images at a display area could similarly be dimensioned to fit within a price ticket channel of conventional grocery store shelving. Other embodiments may be secured to the front edge of a shelf by means other than a price ticket channel, for example using adhesive, clips or other fasteners to secure the strip directly to the front edge itself. Such a display need not necessarily have an elongated strip-like shape, but this has the benefit of not significantly projecting upward or downward from a shelf and obscuring product on that shelf or one therebelow. The number of display areas may be increased or decreased from that shown in the drawings, and small displays each featuring only a single display area may be produced, in which case the whole strip could be configured to illuminate. Embodiments featuring power control components in fixed connection with the display instead of the releasable electrical interface of the illustrated embodiment may also be possible. The display area of Furthermore, other embodiments could be configured to connect to suitable power sources other than mains AC power, such as battery-powered operation at 12 volts for example.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An illuminating display for a store shelf having a price ticket channel extending along an outer edge of the shelf with upper and lower lips extending in a longitudinal direction of the channel at top and bottom sides thereof, the illuminating display comprising:
a strip having a width dimension sized for receipt of the strip within the channel between the upper and lower lips to extend a length dimension of the strip along the longitudinal direction of the channel; and
at least one illuminating display area defined on the strip to face outward from the channel away from the shelf and illuminate under activation of an light source carried on the strip and associated with the display area.

2. The illuminating display of claim 1 wherein each illuminating display area is illuminated by a respective electroluminescent light source operably disposed at said display area.

3. The illuminating display of claim 1 wherein the at least one illuminating display area comprises a plurality of illuminating display areas spaced apart along the length dimension of the strip.

4. The illuminating display of claim 1 wherein one or more illuminating display areas are each configured to display a product name or logo.

5. The illuminating display claim 1 comprising a controller electrically coupled with each light source to control illumination of the at least one illuminating display area.

6. The illuminating display of claim 5 comprising a releasable electrical interface connected between the controller and each light source to facilitate selective disconnection of the controller from each light source.

7. The illuminating display of claim 4 wherein the controller is arranged to control a sequence in which multiple illuminating display areas are illuminated.

8. The illuminating display of claim 7 wherein the controller is arranged to effect illumination the multiple illuminating display areas in sequence along the strip.

9. The illuminating display of claim 8 wherein the controller is arranged to deactivate the illumination of each multiple illuminating display area only after all of the multiple illuminating display areas have been illuminated.

10. The illuminating display of claim 4 wherein the controller comprises a micro-controller.

11. A store display comprising:
a shelf defining a support surface and an outer edge extending along one side of the support surface; and
an illuminating display supported on the shelf to face away from the shelf and the outer edge thereof, the illuminating display comprising:
a body secured to the shelf;
at least one illuminating display area carried on the body and visible from a side thereof facing outward from the shelf; and
at least one light source carried on the body and operable to illuminate the at least one illuminating display area.

12. The store display according to claim 11 wherein the body of the display comprises a sheet of material on which each illuminating display area and light source are carried.

13. The store display according to claim 12 each illuminating display area is illuminated by a electroluminescent light source operably defined on the sheet of material at said illuminating display area.

14. The store display according to claim 12 wherein the sheet of material is a strip of material having a length dimension extending along the outer edge of the shelf.

15. The store display according to claim 11 wherein the illuminating display is provided in the form of a strip extending along the outer edge of the shelf.

16. The store display according to claim 15 wherein a top edge of the strip is disposed at an elevation below the support surface of the shelf.

17. The store display according to claim 15 wherein a height dimension of the strip does not exceed a height dimension of the shelf at an outermost extent of the shelf on the same side of the support surface as the outer edge.

18. The store display according to claim 11 wherein the shelf comprises a price ticket channel extending along the outer edge on a side thereof opposite the support surface, the ticket channel comprising upper and lower lips extending in a longitudinal direction of the channel on opposite top and bottom sides of a face of channel facing away from the outer edge and the body of the illuminating display being disposed within the channel between the upper and lower lips thereof.

19. The store display according to claim 11 further comprising a controller electrically coupled with each light source to control illumination of the at least one illuminating display area.

20. The store display according to claim 19 wherein the controller is operable at a distance from where the body of the illuminating display is secured to the shelf.
